(19) United States
(12) Patent Application Publication
(10) Pub. No.: US 2026/0351458 A1
(43) Pub. Date: Nov. 5, 2026

(54) REACTOR, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yoshinori TAKAI, Mie (JP); Masato NADA, Mie (JP); Shinichiro YAMAMOTO, Mie (JP)

(21) Appl. No.: 19/488,074

(22) PCT Filed: May 10, 2024
(86) PCT No.: PCT/JP2024/017513

§ 371 Date: Nov. 26, 2025

(30) Foreign Application Priority Data
May 30, 2023 (JP) 2023-088799

(51) Int. Cl. H01F 27/24; H01F 27/28

(52) U.S. Cl. CPC H01F 27/24; H01F 27/28

(57) ABSTRACT

This reactor includes: a coil; and a magnetic core having an inner core portion disposed inside the coil and an outer core portion disposed outside the coil. The inner core portion includes: a first core portion and a second core portion arranged side by side in an X direction extending along an axis of the coil; a gap plate disposed between the first core portion and the second core portion; and a connecting core portion connecting the first core portion and the second core portion to each other. The first core portion, the second core portion, and the connecting core portion are integrally molded from a composite material in which a soft magnetic powder is dispersed in a resin.

### TECHNICAL FIELD

The present disclosure relates to a reactor, a converter, and a power conversion device.

This application is based upon and claims the benefit of priority from Japanese Patent Application No. 2023-088799 filed in Japan on May 30, 2023, the entire content of which is hereby incorporated by reference.

### BACKGROUND

Patent Documents 1 and 2 each disclose a reactor that includes a coil and a magnetic core. In the reactor of Patent Document 1, the magnetic core includes a plurality of magnetic bodies and gap members inserted between the magnetic bodies. The gap members are plate-shaped. The magnetic bodies and the gap members are adhered to each other. In the reactor of Patent Document 2, the magnetic core includes inner core pieces arranged inside the coil and outer core pieces arranged outside the coil, and the inner core pieces and the outer core pieces are integrated with each other by a resin molded portion that covers the magnetic core. This magnetic core includes a plurality of inner core pieces, and also has gap portions between adjacent inner core pieces. In one example of Patent Document 2, inner wall portions of inner segment pieces disposed between adjacent inner core pieces function as the gap portions.

### PRIOR ART DOCUMENT

### Patent Document

Patent Document 1: JP 2006-294830 A
Patent Document 2: JP 2018-148088 A

### SUMMARY OF THE INVENTION

A reactor according to an aspect of the present disclosure includes: a coil; and a magnetic core having an inner core portion disposed inside the coil and an outer core portion disposed outside the coil. The inner core portion includes: a first core portion and a second core portion arranged side by side in an X direction extending along an axis of the coil; a gap plate disposed between the first core portion and the second core portion; and a connecting core portion connecting the first core portion and the second core portion to each other. The first core portion, the second core portion, and the connecting core portion are integrally molded from a composite material in which a soft magnetic powder is dispersed in a resin.

### BRIEF DESCRIPTION OF THE DRAWINGS

FIG. 1 is a schematic perspective view of a reactor according to an embodiment.

FIG. 2 is a schematic plan view of the reactor according to the embodiment.

FIG. 3 is a schematic plan view illustrating a magnetic core provided in the reactor according to the embodiment.

FIG. 4 is a cross-sectional view taken along line IV-IV in FIG. 3.

FIG. 5 is a cross-sectional view illustrating a modified example of a gap plate shown in FIG. 4.

FIG. 6 is a schematic plan view illustrating a gap plate and a spacer provided in the reactor according to the embodiment.

FIG. 7 is a cross-sectional view taken along line VII-VII in FIG. 6.

FIG. 8 is a schematic perspective view of a first spacer provided in the reactor according to the embodiment.

FIG. 9 is a schematic perspective view of a second spacer provided in the reactor according to the embodiment.

FIG. 10 is a schematic perspective view of a coil provided in the reactor according to the embodiment.

FIG. 11 is a schematic configuration diagram illustrating a power supply system of a hybrid vehicle.

FIG. 12 is a schematic circuit diagram illustrating a power conversion device that includes a converter.

### DETAILED DESCRIPTION TO EXECUTE THE INVENTION

### Technical Problem

In the technology of Patent Documents 1 and 2, a magnetic core that includes gap portions is formed by combining a plurality of core pieces and gap plates. The gap plates are disposed between the core pieces. Two adjacent core pieces on opposite sides of a gap plate are separated by the gap plate. In other words, adjacent core pieces do not form a single continuous member, but rather are independent members.

In conventional magnetic cores, the mechanical strength of the joint between a core piece and a gap plate may not be sufficient. If the magnetic core is subjected to vibration, shock, or repeated stress, a core piece may become separated from a gap plate. If a core piece becomes separated from a gap plate, the magnetic core breaks down. For example, in the case where a gap plate is provided in an inner core portion located inside a coil, if a core piece becomes separated from the gap plate, there is a possibility that the inner core portion will come out of the coil. Therefore, it is desirable to increase the mechanical strength of the magnetic core in which the gap plate is disposed.

An object of the present disclosure is to provide a reactor in which the mechanical strength of the magnetic core can be increased even when a gap plate is provided in the magnetic core.

### Advantageous Effects of Present Disclosure

According to the reactor of the present disclosure, even when a gap plate is provided in the magnetic core, the mechanical strength of the magnetic core can be increased.

### Description of Embodiments of Present Disclosure

First, embodiments of the present disclosure will be listed and described.

(1) A reactor according to an aspect of the present disclosure includes: a coil; and a magnetic core having an inner core portion disposed inside the coil and an outer core portion disposed outside the coil. The inner core portion includes: a first core portion and a second core portion arranged side by side in an X direction extending along an axis of the coil; a gap plate disposed between the first core portion and the second core portion; and a connecting core portion connecting the first core portion and the second core portion to each other. The first core portion, the second core portion, and the connecting core portion are integrally molded from a composite material in which a soft magnetic powder is dispersed in a resin.

In the reactor of this aspect of the present disclosure, the gap plate is provided in the inner core portion. The inner core portion is an integral body in which the first core portion and the second core portion, which are adjacent to each other with the gap plate interposed therebetween, are connected to each other by the connecting core portion. Therefore, the first core portion and the second core portion are not separated by the gap plate. Since the first core portion and the second core portion are connected by the connecting core portion, the first core portion and the second core portion are unlikely to become separated from each other. Since the strength of the joining of the first core portion and the second core portion to the gap plate is high, the mechanical strength of the inner core portion is improved. Therefore, in the reactor of this aspect of the present disclosure, even when the gap plate is provided in the inner core portion, the mechanical strength of the magnetic core can be increased.

Furthermore, according to the reactor of this aspect of the present disclosure, there is no need to adhere the first core portion and the second core portion to the gap plate or to integrate them with a resin molded portion. Therefore, the productivity of the reactor is high.

(2) In the reactor according to (1), the gap plate may have a first surface in contact with the first core portion, a second surface in contact with the second core portion, and a through-hole extending from the first surface to the second surface. The connecting core portion may include a first connecting core portion provided in the through-hole.

In the above configuration (2), the first core portion and the second core portion are connected by the first connecting core portion provided in the through-hole of the gap plate. When magnetic flux flows in the inner core portion, the magnetic flux passing through the connecting core portion flows concentratedly in the first connecting core portion, which makes it easier to reduce magnetic flux leaking outward from the gap plate.

(3) In the reactor according to (1) or (2), in a view of the inner core portion from the X direction, an area of an outline of the gap plate may be smaller than an area of an outline of each of the first core portion and the second core portion. The connecting core portion may include a second connecting core portion provided outward of an outer peripheral surface of the gap plate.

In the above configuration (3), the first core portion and the second core portion are connected by the second connecting core portion provided outward of the gap plate. When magnetic flux flows in the inner core portion, the magnetic flux passing through the connecting core portion flows concentratedly in the second connecting core portion, which makes it easier to reduce magnetic flux leaking outward from the gap plate.

(4) The reactor according to any of (1) to (3) may further include a spacer disposed at at least one end portion of the coil. The spacer may have a support portion supporting the gap plate.

According to the above configuration (4), it is easy to arrange the gap plate at a predetermined position in the inner core portion.

(5) In the reactor according to any of (1) to (4), the gap plate may have: a first surface in contact with the first core portion; a second surface in contact with the second core portion; and a hook portion provided on at least one surface out of the first surface and the second surface. The hook portion may have: a shaft portion protruding in the X direction from the at least one surface of the gap plate; and a head portion protruding from a leading end of the shaft portion in a direction intersecting the X direction.

According to the above configuration (5), the hook portion becomes caught on at least one of the first core portion and the second core portion, thereby making it unlikely for the corresponding core portion to become separated from the gap plate. The strength of the joining of the corresponding core portion out of the first core portion or the second core portion to the gap plate is increased.

(6) In the reactor according to (2), the gap plate may have a hook portion provided on at least one surface out of the first surface and the second surface. The hook portion may have: a shaft portion protruding in the X direction from the at least one surface of the gap plate; and a head portion protruding from a leading end of the shaft portion in a direction intersecting the X direction. In a view of the gap plate from the X direction, the head portion may be at a position overlapping the through-hole.

According to the above configuration (6), the head portion of the hook portion is at a position overlapping the through-hole, thereby making it easier to adjust the magnetic resistance between the first core portion and the second core portion.

(7) In the reactor according to any of (1) to (6), the connecting core portion may have a cross-sectional area of 1 mm² or more and ₂₀ mm² or less.

Due to the cross-sectional area of the connecting core portion being 1 mm² or more, the strength of the joining of the first core portion and the second core portion to the gap plate can be increased. Due to the cross-sectional area of the connecting core portion being 20 mm² or less, the magnetic flux passing through the connecting core portion is reduced, thereby making it easier to adjust the magnetic characteristics of the magnetic core.

(8) In the reactor according to any of (1) to (7), the gap plate may have a thickness of 0.5 mm or more and 3 mm or less.

According to the above configuration (8), the magnetic characteristics of the magnetic core can be easily adjusted.

(9) In the reactor according to any of (1) to (8), the outer core portion may be integrally molded with the first core portion, the second core portion, and the connecting core portion.

According to the above configuration (9), there is no need to adhere the inner core portion and the outer core portion to each other or to integrate them with a resin molded portion. Therefore, the productivity of the reactor is high.

(10) In the reactor according to any of (1) to (9), in a view of the magnetic core from the X direction, a vertical dimension of the magnetic core may be ⅓ or less of a horizontal dimension of the magnetic core.

According to the above configuration (10), the reactor has a low profile.

(11) In the reactor according to any of (1) to (10), the magnetic core may have a vertical dimension of 20 mm or less.

According to the above configuration (11), the reactor has a low profile.

(12) A converter according to an aspect of the present disclosure includes the reactor according to any one of (1) to (11).

In the reactor of this aspect of the present disclosure, the magnetic core has high mechanical strength. Therefore, the converter of this aspect of the present disclosure operates stably.

(13) A power conversion device according to an aspect of the present disclosure includes the converter according to (12).

The power conversion device of this aspect of the present disclosure includes the converter of the above aspect of the present disclosure, and therefore operates stably.

### Details of Embodiments of Present Disclosure

Specific examples of embodiments of the present disclosure will be described below with reference to the drawings. Reference numerals that are the same as each other in the figures indicate the same or corresponding parts.

### Reactor

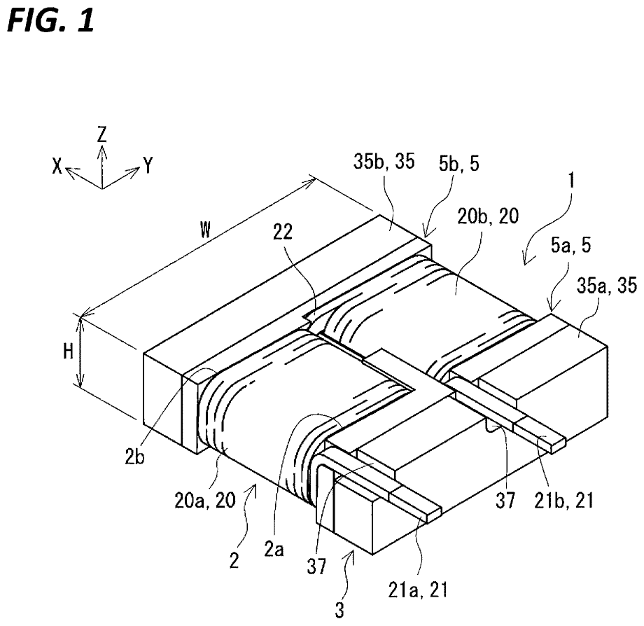

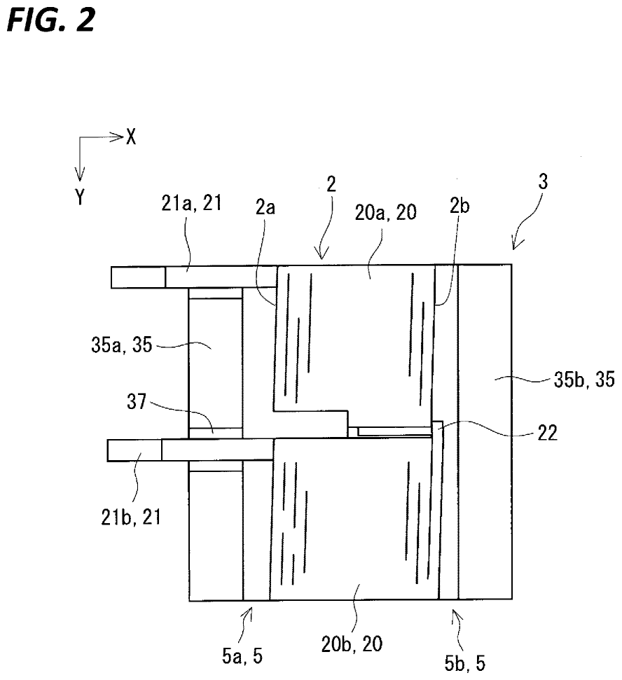

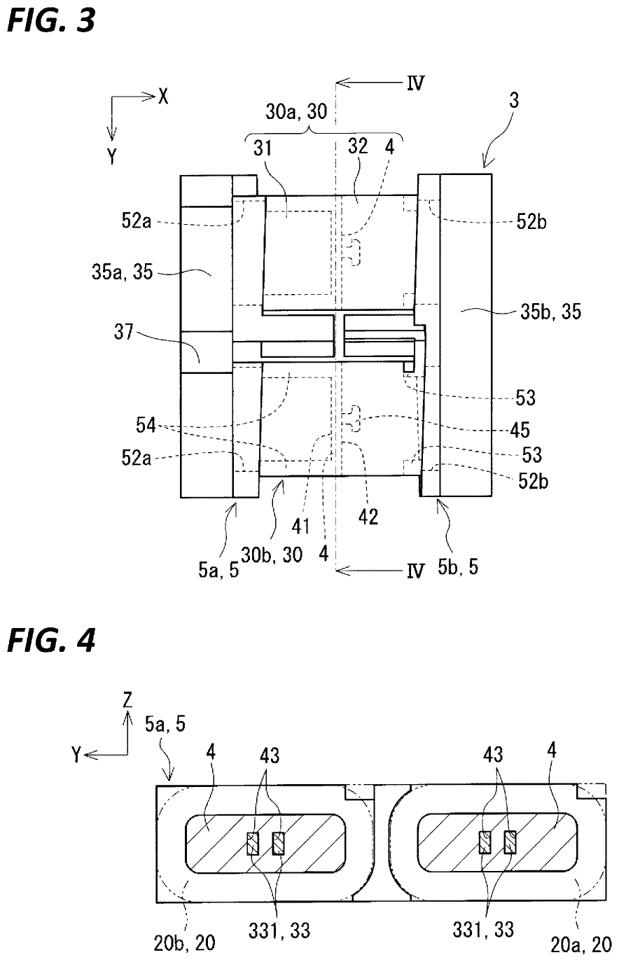

A reactor 1 according to an embodiment will be described below with reference to FIGS. 1 to 10. As shown in FIGS. 1 and 2, the reactor 1 includes a coil 2 and a magnetic core 3. The magnetic core 3 has inner core portions 30 and outer core portions 35. As shown in FIG. 3, each of the inner core portions 30 includes a first core portion 31, a second core portion 32, and a gap plate 4. The gap plate 4 is disposed between the first core portion 31 and the second core portion 32.

One of the features of the reactor 1 of this embodiment is that each of the inner core portions 30 has a connecting core portion 33, as shown in FIGS. 3 and 4. The first core portion 31 and the second core portion 32, which are adjacent to each other with the gap plate 4 interposed therebetween, are continuous with and connected to each other by the connecting core portion 33. The first core portion 31, the second core portion 32, and the connecting core portion 33 are integrally molded from a composite material, which will be described later. The components of the reactor 1 will be described in detail below.

In the following description, an X direction, a Y direction, and a Z direction of the reactor 1 are defined as follows. The X direction extends along the axis of the coil 2. Specifically, the axis of the coil 2 is the X axis, and the direction from a first end portion 2a of the coil 2 to a second end portion 2b of the same is the X direction. A line orthogonal to the side surfaces of the coil 2 is defined as the Y axis, and the direction from a first side surface of the coil 2 to a second side surface of the same is the Y direction. The X axis and the Y axis are orthogonal to each other. The Y direction is orthogonal to the X direction. The Y direction is the horizontal direction. A line orthogonal to the X axis and the Y axis is the Z axis, and the direction from the lower surface of the coil 2 to the upper surface of the same is the Z direction. The Z direction is orthogonal to both the X direction and the Y direction. The Z direction is the vertical direction.

### Coil

The configuration of the coil 2 will be described below mainly with reference to FIGS. 1, 2, and 10. As shown in FIGS. 1 and 2, the coil 2 has winding portions 20. The coil 2 is formed by a winding wire. The winding portions 20 are each formed by winding a wire into a spiral. The direction in which the axes of the winding portions 20 extend coincides with the X direction. The winding wire is, for example, a coated flat wire having a conductor wire and an insulating coating covering the conductor wire. The conductor wire is, for example, a flat copper wire. The insulating coating is made of, for example, enamel. The coil 2 in this example is an edgewise coil in which a coated flat wire is wound into a spiral.

In this example, two winding portions 20 are provided. The coil 2 of this example has a first winding portion 20a and a second winding portion 20b. The first winding portion 20a and the second winding portion 20b are arranged parallel with each other and spaced apart in the Y direction. The direction along the axis of the first winding portion 20a and the direction along the axis of the second winding portion 20b are substantially parallel to each other. The first winding portion 20a and the second winding portion 20b have substantially the same dimension in the X direction.

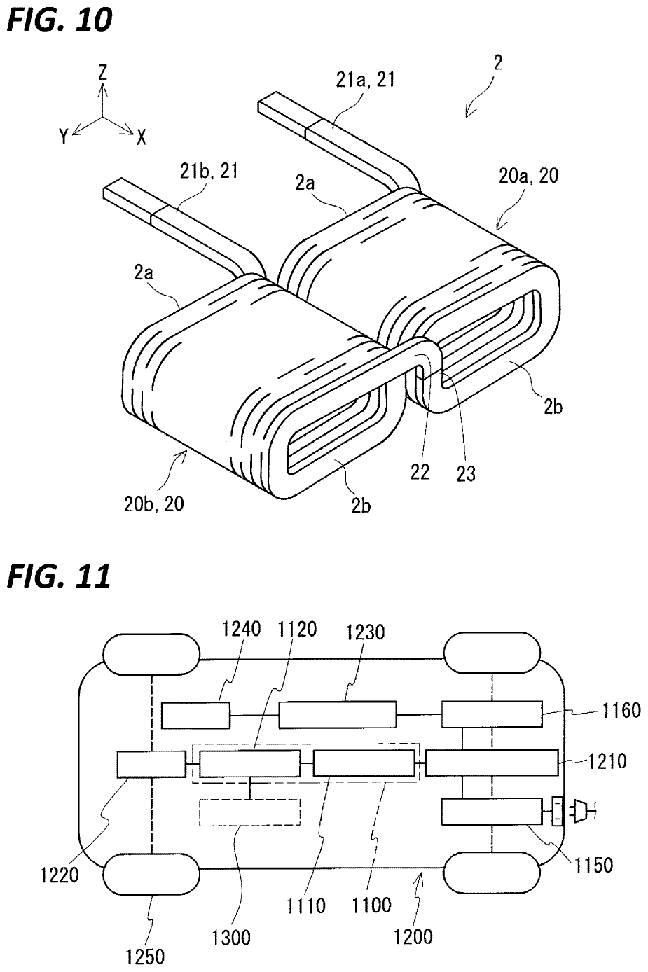

As shown in FIG. 10, each of the winding portions 20 has a cylindrical shape. The winding portion 20 in this example is shaped as a polygonal cylinder. Specifically, the winding portion 20 is shaped as a rectangular cylinder. Being shaped as a rectangular cylinder means that the outline of the end faces of the winding portion 20 is rectangular. The end faces here refer to the surfaces of the end portions of the winding portion 20 when viewed in the X direction. The corners of the winding portion 20 may be rounded. The end faces of the winding portion 20 in this example are rectangular with a pair of straight long sides and a pair of arc-shaped short sides. The long sides extend along the Y axis. The short sides extend along the Z axis. The shape of the first winding portion 20a and the shape of the second winding portion 20b are substantially the same as each other.

The coil 2 has terminal portions 21. In this example, the terminal portions 21 are drawn out from the first end portions 2a of the coil 2. The terminal portions 21 are located on the upper side of the coil 2. The coil 2 of this example has a first terminal portion 21a and a second terminal portion 21b. The first terminal portion 21a is drawn out along the X axis from the first winding portion 20a. The second terminal portion 21b is drawn out along the X axis from the second winding portion 20b. The direction in which the terminal portions 21 are drawn out is opposite to the X direction. The terminal portions 21 are connected to bus bars (not shown). The bus bars connect the coil 2 to a power source (not shown).

As shown in FIG. 10, the second end portion 2b of the coil 2 of this example has a connecting portion 22 that connects the first winding portion 20a to the second winding portion 20b. The connecting portion 22 is a Z-shaped bent portion that connects the turns at the second end portions 2b of the first winding portion 20a and the second winding portion 20b. The connecting portion 22 is formed by a part of the winding that forms the first winding portion 20a and the second winding portion 20b. In this example, the first winding portion 20a and the second winding portion 20b are formed by winding separate winding wires. The winding wires forming the first winding portion 20a and the second winding portion 20b are continuous with and connected to each other by a joint 23 provided at an intermediate point along the connecting portion 22. The joint 23 is a location where the winding wiring forming the first winding portion 20a and the winding wire forming the second winding portion 20b are joined to each other. In this example, the joint 23 is formed by abutting the end face of the winding wire forming the first winding portion 20a against the end face of the winding wire forming the second winding portion 20b and cold welding to end faces to each other. The coil 2 can be obtained by forming the majority of the first winding portion 20a and the majority of the second winding portion 20b, cold welding the winding wires together, and then forming the remainder of the first winding portion 20a and the second winding portion 20b. As an alternative to this example, the coil 2 may be formed by a single winding wire. In this case, the first winding portion 20a, the connecting portion 22, and the second winding portion 20b are formed by a continuous winding wire, and the connecting portion 22 does not have the joint 23.

### Magnetic Core

The configuration of the magnetic core 3 will be described below mainly with reference to FIGS. 2 and 3. The coil 2 is disposed in the magnetic core 3. The magnetic core 3 has the inner core portions 30 and the outer core portions 35. A closed magnetic circuit is formed by the inner core portions 30 and the outer core portions 35 of the magnetic core 3. As shown in FIG. 3, the magnetic core 3 of this example is O-shaped in plan view. When the coil 2 is energized, magnetic flux flows inside the magnetic core 3, and a closed magnetic circuit is formed in the magnetic core 3.

### Inner Core Portion

As shown in FIG. 3, the inner core portions 30 are portions disposed inside the coil 2 shown in FIG. 2. The inner core portions 30 extend along the X axis. The end portions of the inner core portions 30 may protrude from the end portion of the coil 2. These protruding portions are also a part of the inner core portions 30. In other words, the dimension of the inner core portions 30 in the X direction may be longer than the dimension of the coil 2 in the X direction.

The number of inner core portions 30 is the same as the number of winding portions 20. In this example, there are two inner core portions 30. The magnetic core 3 of this example has a first inner core portion 30a and a second inner core portion 30b. The first inner core portion 30a is disposed inside the first winding portion 20a. The second inner core portion 30b is disposed inside the second winding portion 20b. The first inner core portion 30a and the second inner core portion 30b are arranged generally parallel to the X axis, and are arranged parallel to each other with a gap therebetween in the Y direction. The first inner core portion 30a and the second inner core portion 30b have substantially the same dimension as each other in the X direction.

The shape of the inner core portions 30 generally corresponds to the inner shape of the coil 2, that is to say, the winding portions 20. In this example, the inner core portions 30 have a prismatic shape, and a cross section of the inner core portions 30 taken perpendicular to the X direction is rectangular. The shape of the first inner core portion 30a and the shape of the second inner core portion 30b are substantially the same as each other. The outer peripheral surfaces of the inner core portions 30 are in contact with the inner peripheral surface of the coil 2, that is to say, the winding portions 20. This makes it easy to increase the cross-sectional area of the magnetic path of the inner core portions 30.

### First Core Portion and Second Core Portion

As shown in FIG. 3, each of the inner core portions 30 of this example has a first core portion 31 and a second core portion 32. The first core portion 31 and the second core portion 32 are arranged side by side in the X direction. The first core portion 31 and the second core portion 32 have substantially the same cross-sectional shape and cross-sectional area as each other. The cross section here refers to a cross section taken perpendicular to the X direction. In this example, the cross sections of the first core portion 31 and the second core portion 32 are both rectangular.

In this example, a first end portion of each of the inner core portions 30 is connected to a first end core portion 35a, which will be described later. A second end portion of the inner core portion 30 is connected to a second end core portion 35b, which will be described later. The first end portion of the inner core portion 30 is the end portion where the first core portion 31 is located. The second end portion of the inner core portion 30 is the end portion where the second core portion 32 is located.

A gap plate 4, which will be described later, is disposed between the first core portion 31 and the second core portion 32. In other words, the first core portion 31 and the second core portion 32 face each other with the gap plate 4 interposed therebetween. The first core portion 31 is in contact with a first surface 41 of the gap plate 4. The second core portion 32 is in contact with a second surface 42 of the gap plate 4. Furthermore, the first core portion 31 and the second core portion 32 are continuous with and connected to each other by the connecting core portion 33 shown in FIG. 4.

### Gap Plate

The gap plate 4 is a member that adjusts the magnetic characteristics of the magnetic core 3. The gap plate 4 increases the magnetic resistance between the first core portion 31 and the second core portion 32 and adjusts the amount of magnetic flux flowing inside the inner core portion 30. By providing the gap plate 4 in the inner core portion 30, it is possible to, for example, prevent magnetic saturation of the inner core portion 30 and to increase the inductance of the magnetic core 3. The gap plate 4 has the first surface 41 in contact with the first core portion 31 and the second surface 42 in contact with the second core portion 32. The gap plate 4 in this example is provided in an intermediate portion of the inner core portion 30.

The configuration of the gap plate 4 will be described below mainly with reference to FIGS. 4 to 7. As shown in FIG. 4, the gap plate 4 of this example has through-holes 43 that penetrate from the first surface 41 to the second surface 42 shown in FIG. 3. The through-holes 43 pass through the gap plate 4 in the X direction. In the case where the gap plate 4 has the through-holes 43, as shown in FIG. 4, the connecting core portion 33 has a first connecting core portion 331, which will be described later. The cross-sectional area of the through-holes 43 can be appropriately selected such that the cross-sectional area of the connecting core portion 33 has a predetermined value. The cross-sectional area of the through-holes 43 is, for example, 1 mm² or more and 20 mm² or less. The cross-sectional area here refers to the area of a cross section taken perpendicular to the X direction. When there are a plurality of through-holes 43, the cross-sectional area of the through-holes 43 is the sum of the cross-sectional areas of all the through-holes 43. When there are two through-holes 43, the sum cross-sectional area of the two through-holes 43 is, for example, 1 mm² or more and 20 mm² or less. The cross-sectional area of the through-holes 43 may further be 2 mm² or more and 15 mm² or less, or 3 mm² or more and 10 mm² or less.

The cross-sectional shape of the through-holes 43 may be polygonal, or may be circular. Examples of polygonal shapes include a triangle and a quadrangle. The cross section of the through-holes 43 in this example is rectangular. There may be one or more through-holes 43. In this example, there are two through-holes 43. In this example, two through-holes 43 are arranged side by side with a gap therebetween in the Y direction. The positions of the through-holes 43 can be selected appropriately.

The outline shape of the gap plate 4 may be the same as or different from the outline shapes of the first core portion 31 and the second core portion 32 shown in FIG. 3. When the inner core portion 30 is viewed from the X direction, the outline shape of the gap plate 4 is a shape that does not protrude beyond the first core portion 31 and the second core portion 32. The outline shape of the gap plate 4 of this example is rectangular as shown in FIG. 4, and is substantially the same as the outline shape of the first core portion 31 and the second core portion 32. Furthermore, the area of the outline of the gap plate 4 of this example shown in FIG. 4 is substantially the same as the area of the outline of the first core portion 31 and the outline of the second core portion 32. The outline shape refers to the outline shape of the outer periphery of the member when the inner core portion 30 is viewed from the X direction. The area of the outline is the area of the outline shape.

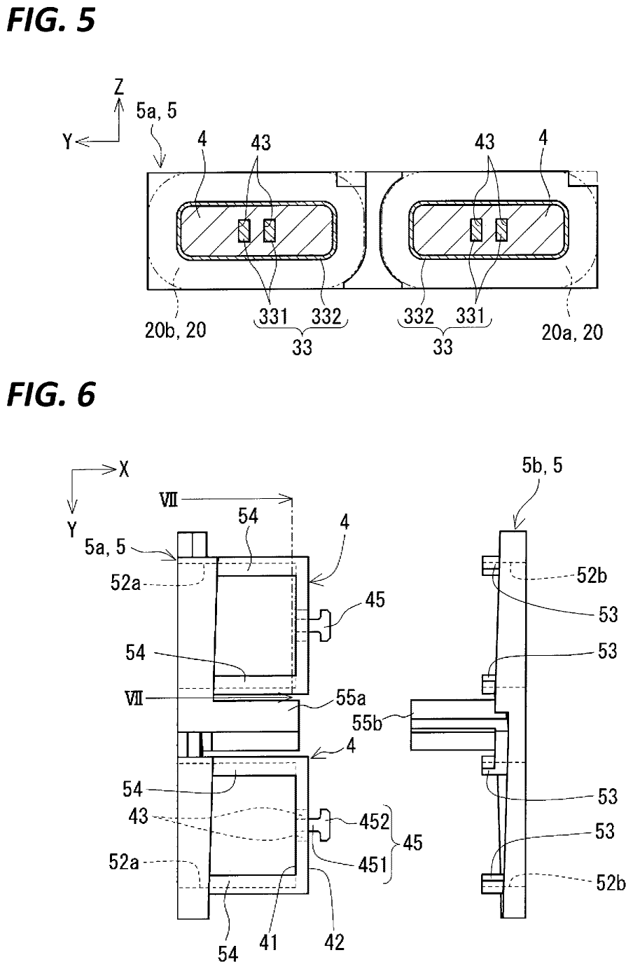

As an alternative to the present embodiment, the area of the outline of the gap plate 4 may be smaller than the area of the outline of the first core portion 31 and the outline of the second core portion 32. In the case where the area of the outline of the gap plate 4 is smaller than the area of the outline of the first core portion 31 and the outline of the second core portion 32, as exemplified in FIG. 5, the connecting core portion 33 has a second connecting core portion 332, which will be described later. FIG. 5 shows a cross section taken along the same line as the section line IV-IV in FIG. 3. In FIG. 5, the second connecting core portion 332 is shown in an exaggerated manner for clarity. The gap plate 4 shown in FIG. 5 has a rectangular outline shape, and the area of the outline is slightly smaller than the area of the outline of the first core portion 31 and the outline of the second core portion 32. The area of the outline of the gap plate 4 can be appropriately selected such that the cross-sectional area of the connecting core portion 33 has a predetermined value. The difference between the area of the outline of the first core portion 31 or the second core portion 32 and the area of the outline of the gap plate 4 is, for example, 1 mm² or more and 20 mm² or less. The outline area difference may further be 2 mm² or more and 15 mm² or less, or 3 mm² or more and 10 mm 2 or less. In FIG. 5, the outline area difference is shown in an exaggerated manner, and therefore the outline area difference is shown larger than the cross-sectional area of the through-holes 43. In the case of the gap plate 4 of this example shown in FIG. 4, the outline shape of the gap plate 4 is the same as the outline shapes of the first core portion 31 and the second core portion 32, and the outline area difference is substantially zero.

A groove extending from the first surface 41 to the second surface 42 may be formed in the outer peripheral surface of the gap plate 4. When the gap plate 4 has such a groove in the outer peripheral surface, the area of the outline of the gap plate 4 becomes smaller.

The gap plate 4 shown in FIG. 5 has the through-holes 43, and the area of the outline of the gap plate 4 is smaller than the area of the outline of the first core portion 31 and the outline of the second core portion 32. In the case where the gap plate 4 has the through-holes 43, the outline shape and the area of the outline of the gap plate 4 may be the same as the outline shape and the area of the outline of both the first core portion 31 and the second core portion 32. In this case, the connecting core portion 33 does not include the second connecting core portion 332, which will be described later. In the case where the area of the outline of the gap plate 4 is smaller than the area of the outline of the first core portion 31 and the area of the outline of the second core portion 32, the gap plate 4 does not need to have the through-holes 43. In this case, the connecting core portion 33 does not include the first connecting core portion 331, which will be described later.

The thickness of the gap plate 4 is, for example, 0.5 mm or more and 3 mm or less. The thickness of the gap plate 4 is the dimension of the gap plate 4 in the X direction. In other words, the thickness of the gap plate 4 is the distance between the first surface 41 and the second surface 42. When the thickness of the gap plate 4 is 0.5 mm or more and 3 mm or less, the magnetic characteristics of the magnetic core 3 can be easily adjusted. When the thickness of the gap plate 4 is 0.5 mm or more, the mechanical strength of the gap plate 4 can be easily increased. When the thickness of the gap plate 4 is 3 mm or less, leakage magnetic flux from the gap plate 4 can be easily reduced. The thickness of the gap plate 4 may further be 1 mm or more and 2.5 mm or less, or 1 mm or more and 2 mm or less.

The gap plate 4 is made of a non-magnetic material such as a resin or a ceramic. The resin forming the gap plate 4 may be a thermoplastic resin or a thermosetting resin. Examples of the thermoplastic resin include polyphenylene sulfide (PPS) resin, polytetrafluoroethylene (PTFE) resin, liquid crystal polymer (LCP), polyamide (PA) resin, polybutylene terephthalate (PBT) resin, and acrylonitrile butadiene styrene (ABS) resin. Examples of the polyamide resin include nylon 6, nylon 66, and nylon 9T. Examples of the thermosetting resin include an unsaturated polyester resin, an epoxy resin, a urethane resin, and a silicone resin. The gap plate 4 in this example is made of a resin.

### Hook Portion

The gap plate 4 may have a hook portion 45 as shown in FIG. 6. The hook portion 45 is provided on at least one of the first surface 41 and the second surface 42. In this example, one hook portion 45 is provided on the second surface 42. The hook portion 45 in this example is integrated with the gap plate 4. In other words, the gap plate 4 and the hook portion 45 are an integral body. The hook portion 45 has a shaft portion 451 and a head portion 452. The hook portion 45 of this example is T-shaped in plan view.

The shaft portion 451 protrudes from at least one surface of the gap plate 4 and extends along the X axis. In this example, the shaft portion 451 protrudes from the second surface 42 and extends in the X direction. The shape of the shaft portion 451 may be a prismatic column or a cylindrical column. In this example, the shaft portion 451 is shaped as a prismatic column, and the cross section of the shaft portion 451 is rectangular. In this example, the shaft portion 451 is located between the two through-holes 43. The position of the shaft portion 451 can be selected as appropriate.

The head portion 452 protrudes from the tip of the shaft portion 451 in a direction intersecting the X direction. In this example, the head portion 452 protrudes from the shaft portion 451 in a direction orthogonal to the X direction. Specifically, the head portion 452 protrudes from the shaft portion 451 along the Y axis. The head portion 452 in this example is shaped as a prismatic column. The head portion 452 may protrude from the shaft portion 451 along the Z axis, or may protrude entirely around the shaft portion 451. As long as the head portion 452 protrudes beyond shaft portion 451, the head portion 452 may have any shape. The head portion 452 may be shaped as a pyramid, a cone, a cylinder, or a hemisphere, for example.

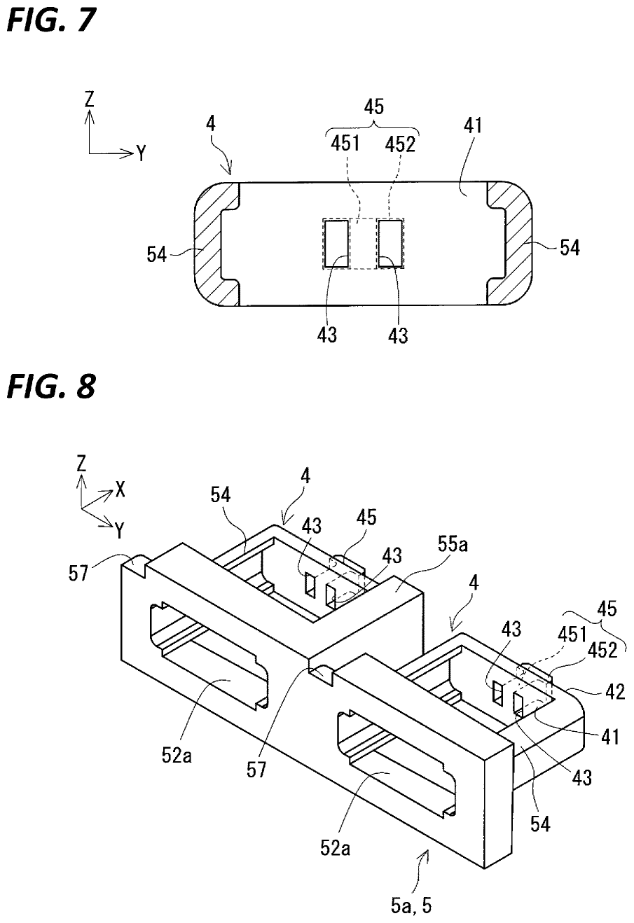

In this example, as shown in FIG. 7, the head portion 452 is provided at a position overlapping the through-holes 43 when the gap plate 4 is viewed from the X direction. Since the head portion 452 is provided at a position overlapping the through-holes 43, the head portion 452 blocks the flow of magnetic flux passing along the X axis through the first connecting core portion 331, which will be described later. Since the flow of magnetic flux passing through the first connecting core portion 331 is blocked by the head portion 452, the magnetic resistance between the first core portion 31 and the second core portion 32 can be easily adjusted.

In the case where the hook portion 45 is provided on the second surface 42, the hook portion 45 is embedded in the second core portion 32 as shown in FIG. 3. The hook portion 45 becomes caught on the second core portion 32, thus making it unlikely for the second core portion 32 to become separated from the gap plate 4. The strength of the joining of the second core portion 32 to the gap plate 4 is increased. As an alternative to the present embodiment, the hook portion 45 may be provided on the first surface 41. In the case where the hook portion 45 is provided on the first surface 41, the hook portion 45 is embedded in the first core portion 31. In this case, the hook portion 45 becomes caught on the first core portion 31, thus making it unlikely for the first core portion 31 to become separated from the gap plate 4, and therefore the strength of the joining of the first core portion 31 to the gap plate 4 is increased. The hook portion 45 may be provided on both the first surface 41 and the second surface 42. In the case where the hook portion 45 is provided on both the first surface 41 and the second surface 42, the first core portion 31 and the second core portion 32 are unlikely to become separated from the gap plate 4, thus increasing the strength of the joining of the first core portion 31 and the second core portion 32 to the gap plate 4.

There may be one or more hook portions 45. Two or more hook portions 45 may be provided on the second surface 42, two or more hook portions 45 may be provided on the first surface 41, and one or more hook portions 45 may be provided on each of the first surface 41 and the second surface 42. The one or more hook portions 45 may be located at any position.

### Connecting Core Portion

The connecting core portion 33 is a portion that connects the first core portion 31 and the second core portion 32 to each other. The first core portion 31 and the second core portion 32, which are adjacent to each other with the gap plate 4 interposed therebetween, are connected to each other by the connecting core portion 33 to form an integral body. In other words, the first core portion 31 and the second core portion 32 are not separated by the gap plate 4. Since the first core portion 31 and the second core portion 32 are connected by the connecting core portion 33, the first core portion 31 and the second core portion 32 are unlikely to become separated from each other. Since the strength of the joining of the first core portion 31 and the second core portion 32 to the gap plate 4 is high, the mechanical strength of the inner core portion 30 is improved. Therefore, since the inner core portion 30 has a high mechanical strength, the mechanical strength of the magnetic core 3 can be increased.

The configuration of the connecting core portion 33 will be described below mainly with reference to FIGS. 4 and 5. The connecting core portion 33 includes one or both of the first connecting core portion 331 and the second connecting core portion 332. The connecting core portion 33 need only include either the first connecting core portion 331 or the second connecting core portion 332. As shown in FIG. 4, the connecting core portion 33 of this example has only the first connecting core portion 331, and does not include the second connecting core portion 332. As shown in FIG. 5, the connecting core portion 33 may have both the first connecting core portion 331 and the second connecting core portion 332. The first connecting core portion 331 shown in FIGS. 4 and 5 is provided in the through-holes 43 of the gap plate 4. The second connecting core portion 332 shown in FIG. 5 is provided on the outer side of the outer peripheral surface of the gap plate 4. The second connecting core portion 332 is disposed between the outer peripheral surface of the gap plate 4 and the inner peripheral surface of the coil 2, that is to say, the winding portion 20.

The cross-sectional area of the connecting core portion 33 is, for example, 1 mm² or more and 20 mm² or less. The cross-sectional area of the connecting core portion 33 here refers to the cross-sectional area of the connecting core portion 33 in one inner core portion 30. When the cross-sectional area of the connecting core portion 33 is 1 mm² or more, the joining strength can be increased, and the mechanical strength of the inner core portion 30 can be easily increased. When the cross-sectional area of the connecting core portion 33 is 20 mm² or less, the magnetic flux passing through the connecting core portion 33 can be reduced, and it is easier to adjust the magnetic characteristics of the magnetic core 3. The smaller the cross-sectional area of the connecting core portion 33 is, the larger the cross-sectional area of the gap plate 4 is, and therefore the effect of adjusting the magnetic characteristics by the gap plate 4 can be more easily obtained. When the cross-sectional area of the connecting core portion 33 is 20 mm² or less, for example, it is possible to prevent magnetic saturation of the inner core portion 30 and to increase the inductance of the magnetic core 3. The cross-sectional area of the connecting core portion 33 may further be 2 mm² or more and 15 mm² or less, or 3 mm² or more and 10 mm² or less.

The cross-sectional area of the connecting core portion 33 is the sum of the cross-sectional area of the first connecting core portion 331 and the cross-sectional area of the second connecting core portion 332. In the case where the connecting core portion 33 has only either the first connecting core portion 331 or the second connecting core portion 332, the cross-sectional area of the first connecting core portion 331 or the cross-sectional area of the second connecting core portion 332 satisfies the above-mentioned range of the cross-sectional area of the connecting core portion 33. In the case where the connecting core portion 33 has both the first connecting core portion 331 and the second connecting core portion 332, the sum of the cross-sectional area of the first connecting core portion 331 and the cross-sectional area of the second connecting core portion 332 satisfies the above-mentioned range of the cross-sectional area of the connecting core portion 33. The cross-sectional area of the first connecting core portion 331 is substantially equal to the cross-sectional area of the through-holes 43. The cross-sectional area of the second connecting core portion 332 is substantially equal to the difference between the area of the outline of the gap plate 4 and the area of the outline of the first core portion 31 or the second core portion 32. In the case of the gap plate 4 of this example shown in FIG. 4, the cross-sectional area of the connecting core portion 33 is the same as the cross-sectional area of the first connecting core portion 331. In the case of the gap plate 4 shown in FIG. 4, the outline area difference is substantially zero. In other words, in this example, the cross-sectional area of the second connecting core portion 332 is substantially zero.

In the case where the connecting core portion 33 has the first connecting core portion 331, the magnetic flux passing through the connecting core portion 33 flows concentratedly in the first connecting core portion 331 provided in the through-holes 43 of the gap plate 4. Therefore, it is easy to reduce magnetic flux leaking outward from the gap plate 4. When the cross-sectional area of the first connecting core portion 331 is 1 mm² or more, leakage magnetic flux from the gap plate 4 can be easily reduced.

In the case where the connecting core portion 33 has the second connecting core portion 332, the magnetic flux passing through the connecting core portion 33 flows concentratedly in the second connecting core portion 332 provided on the outer side of the gap plate 4. Therefore, it is easy to reduce the magnetic flux leaking outward from the gap plate 4. When the cross-sectional area of the second connecting core portion 332 is 1 mm² or more, leakage magnetic flux from the gap plate 4 can be easily reduced. In the case where the gap plate 4 has the above-described groove in the outer peripheral surface, the second connecting core portion 332 fits into the groove, thereby increasing the cross-sectional area of the second connecting core portion 332.

### Composite Material

The first core portion 31, the second core portion 32, and the connecting core portion 33 are integrally molded from a composite material. In other words, the first core portion 31, the second core portion 32, and the connecting core portion 33 are an integral body formed from the same composite material. The composite material molded body has a structure in which a soft magnetic powder is dispersed in a resin. The composite material molded body is obtained by injecting a composite raw material, which is a mixture of an unsolidified resin and a soft magnetic powder, into a mold and then allowing the resin to solidify. The content of the soft magnetic powder in the composite material is, for example, 30% by volume or more and 80% by volume or less, when the entire composite material is taken as 100% by volume. The content of the soft magnetic powder in the composite material may further be 50% by volume or more, 60% by volume or more, or 70% by volume or more.

The particles contained in the soft magnetic powder are at least one type selected from the group consisting of soft magnetic metal particles, coated particles (soft magnetic metal particles with an insulating coating), and soft magnetic non-metal particles. Examples of the soft magnetic metal include pure iron and an iron alloy. The iron alloy is, for example, an Fe (iron)-Si (silicon) alloy or an Fe—Ni (nickel) alloy. The insulating coating is made of, for example, a phosphate. The soft magnetic non-metal is, for example, ferrite.

The resin forming the composite material may be a thermoplastic resin or a thermosetting resin. The thermoplastic resin is, for example, a PPS resin, a PTFE resin, an LCP, a PA resin, a PBT resin, or an ABS resin. Examples of the thermosetting resin include an unsaturated polyester resin, an epoxy resin, a urethane resin, and a silicone resin. Alternatively, the resin forming the composite material may be, for example, BMC (bulk molding compound), millable silicone rubber, or millable urethane rubber. BMC is, for example, a mixture of unsaturated polyester and calcium carbonate or glass fiber.

### Outer Core Portion

The outer core portions 35 are portions disposed outside the coil 2, as shown in FIG. 2. The outer core portions 35 are connected to the inner core portions 30 shown in FIG. 3 to form a closed magnetic circuit. The outer core portions 35 in this example include the first end core portion 35a and the second end core portion 35b. The first end core portion 35a is connected to first end portions of the inner core portions 30, that is to say, the first core portions 31. The second end core portion 35b is connected to second end portions of the inner core portions 30, that is to say, the second core portions 32.

The first end core portion 35a and the second end core portion 35b are arranged at respective end portions of the coil 2 so as to face each other. The first end core portion 35a faces the first end portion 2a of the coil 2. The second end core portion 35b faces the second end portion 2b of the coil 2. The first end core portion 35a and the second end core portion 35b each extend along the Y axis. As shown in FIG. 3, the first end core portion 35a is connected to the first end portions of the first inner core portion 30a and the second inner core portion 30b. The first end core portion 35a connects the first end portions of the first inner core portion 30a and the second inner core portion 30b to each other. The second end core portion 35b is connected to the second end portions of the first inner core portion 30a and the second inner core portion 30b. The second end core portion 35b connects the second end portions of the first inner core portion 30a and the second inner core portion 30b to each other. The first end core portion 35a and the second end core portion 35b are aligned generally parallel to the Y axis, and are arranged parallel to each other with a gap therebetween in the X direction.

The first end core portion 35a and the second end core portion 35b may have any shape as long as they connect the end portions of the first inner core portion 30a and the second inner core portion 30b to each other. In this example, the first end core portion 35a and the second end core portion 35b are shaped as a prismatic column, and the shape of cross sections of the first end core portion 35a and the second end core portion 35b taken perpendicular to the Y direction are rectangular. The shape of the first end core portion 35a and the shape of the second end core portion 35b are substantially the same as each other.

As shown in FIG. 1, the first end core portion 35a of this example has recesses 37 in which the terminal portions 21 of the coil 2 are disposed. Due to disposing the terminal portions 21 in the recesses 37, the terminal portions 21 do not interfere with the first end core portion 35a. In this example, two recesses 37 are provided in the upper surface of the first end core portion 35a. The positions of the two recesses 37 correspond to the positions of the first terminal portion 21a and the second terminal portion 21b, respectively.

The outer core portions 35, that is to say, the first end core portion 35a and the second end core portion 35b, are formed of a magnetic material. Each of the outer core portions 35 is, for example, a molded body made of the above-mentioned composite material. The outer core portion 35 may be a coated molded body in which at least a part of a powder compact is coated with a composite material. In the case where the first end core portion 35a is a coated molded body, the recesses 37 can be easily formed.

The powder compact is obtained by compressing and molding a raw material powder containing soft magnetic powder. A powder compact contains a larger amount of soft magnetic powder than a composite material molded body. Therefore, a powder compact has, for example, a higher relative magnetic permeability and a higher saturation magnetic flux density than a composite material molded body. The powder compact may contain, for example, at least one of a binder resin and a molding aid. The content of the soft magnetic powder in the powder compact is, for example, more than 80% by volume and 99.99% by volume or less, when the entire powder compact is taken as 100% by volume. The content of the soft magnetic powder in the powder compact may further be 85% by volume or more and 99% by volume or less.

In this example, the outer core portions 35, that is to say, the first end core portion 35a and the second end core portion 35b, are each a composite material molded body. In this example, the outer core portions 35 are integrated with the first core portions 31, the second core portions 32, and the connecting core portions 33. In other words, the first end core portion 35a (the second end core portion 35b), the first core portion 31, the second core portion 32, and the connecting core portion 33 are an integral body formed from the same composite material. Since the inner core portions 30 and the outer core portions 35 are integral bodies, there is no need to bond the inner core portions 30 and the outer core portions 35 together or to integrate them with a resin mold portion, as in conventional technology.

### Spacer

The reactor 1 of this example may include one or more spacers 5 as shown in FIGS. 1 to 3. A spacer 5 is disposed at at least one end portion of the coil 2. The spacer 5 is a member that positions the coil 2 relative to the magnetic core 3. The spacer 5 is made of resin. The resin for forming the spacer 5 can be the same as the resin for forming the gap plate 4 described above. The resin forming the spacer 5 may be the same as the resin forming the gap plate 4, or may be different.

In this example, a spacer 5 is disposed at each of the two end portions of the coil 2. The reactor 1 of this example includes a first spacer 5a and a second spacer 5b. The first spacer 5a is arranged at the first end portion 2a of the coil 2. The second spacer 5b is arranged at the second end portion 2b of the coil 2. The structure of the spacer 5 will be described below with reference to FIGS. 6, 8, and 9. In the following description of the configurations of the coil 2 and the magnetic core 3, FIGS. 1 to 3 will be referred to as appropriate. Regarding the configuration of the gap plate 4, FIGS. 6 and 7 will be referred to as appropriate.

### First Spacer

The configuration of the first spacer 5a will be described below mainly with reference to FIGS. 6 and 8. The first spacer 5a is shaped as a frame that comes into contact with surfaces of the first end portion 2a of the coil 2. The first spacer 5a in this example has a generally rectangular frame shape. The surface of the first spacer 5a facing the first end portion 2a of the coil 2 comes into contact with the end surfaces of the first winding portion 20a and the second winding portion 20b. The upper surface and the lower surface of the first spacer 5a are substantially flush with the upper surface and the lower surface of the coil 2, respectively.

The first spacer 5a has opening portions 52a in which the first end portions of the inner core portions 30 are disposed. In this example, there are two opening portions 52a. The first end portions of the first inner core portion 30a and the second inner core portion 30b are respectively disposed in the two opening portions 52a. The opening portions 52a have a rectangular shape.

The first spacer 5a of this example has recesses 57 as shown in FIG. 8. The terminal portions 21 of the coil 2 are disposed in the recesses 57. By disposing the terminal portions 21 in the recesses 57, the terminal portions 21 do not interfere with the first spacer 5a. In this example, two recesses 57 are provided on the upper surface of the first spacer 5a. The positions of the two recesses 57 correspond to the positions of the first terminal portion 21a and the second terminal portion 21b, respectively.

The first spacer 5a may have a partition portion 55a disposed between the first winding portion 20a and the second winding portion 20b. The partition portion 55a protrudes from the surface of the first spacer 5a that faces the first end portion 2a of the coil 2. The partition portion 55a protrudes in the X direction. The partition portion 55a is sandwiched between the opposing side surfaces of the first winding portion 20a and the second winding portion 20b. The partition portion 55a is provided in a region close to the first end portion 2a of the coil 2. The dimension of the partition portion 55a in the X direction is less than half the dimension of the winding portions 20 in the X direction.

### Support Portion

Furthermore, the first spacer 5a of this example has support portions 54 that support the gap plates 4. The support portions 54 extend in the X direction from the surface of the first spacer 5a that faces the first end portion 2a of the coil 2 to the gap plates 4. The leading ends of the support portions 54 are connected to the first surfaces 41 of the gap plates 4. In this example, the gap plates 4 are supported by the first spacer 5a by two support portions 54. The support portions 54 come into contact with the inner surfaces of the side surfaces of the winding portions 20. The cross section of the support portions 54 taken perpendicular to the X direction is C-shaped corresponding to the inner surfaces of the side surfaces of the winding portion 20, as shown in FIG. 7. The support portions 54 are disposed between the inner peripheral surfaces of the winding portions 20 and the outer peripheral surfaces of the inner core portions 30. The portions of the outer peripheral surfaces of the inner core portions 30 where the support portions 54 are arranged do not come into contact with the inner peripheral surfaces of the winding portions 20. Due to the first spacer 5a having the support portions 54, the gap plates 4 can be positioned inside the winding portions 20. Furthermore, the support portions 54 have a function of positioning the winding portions 20 on the first spacer 5a.

In this example, the support portions 54 and the partition portion 55a are integrated with the first spacer 5a. Furthermore, the gap plates 4 are integrated with the support portions 54. In other words, the gap plates 4 and the first spacer 5a are an integral body formed from the same resin.

### Second Spacer

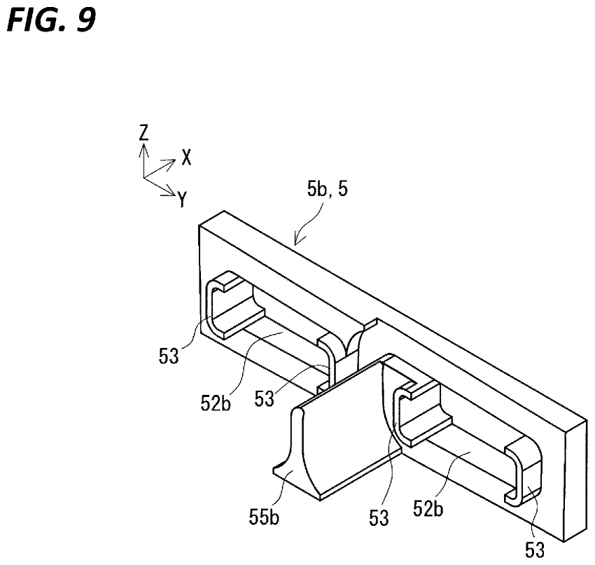

The configuration of the second spacer 5b will be described below mainly with reference to FIGS. 6 and 9. The second spacer 5b is shaped as a frame that comes into contact with surfaces of the second end portion 2b of the coil 2. The second spacer 5b in this example has a generally rectangular frame shape. The surface of the second spacer 5b that faces the second end portion 2b of the coil 2 comes into contact with the end surfaces of the first winding portion 20a and the second winding portion 20b. The upper surface and the lower surface of the second spacer 5b are substantially flush with the upper surface and the lower surface of the coil 2, respectively.

The second spacer 5b has opening portions 52b in which the second end portions of the inner core portions 30 are disposed. In this example, there are two opening portions 52b. The second end portions of the first inner core portion 30a and the second inner core portion 30b are respectively disposed inside the two opening portions 52b. The opening portions 52b have a rectangular shape.

The second spacer 5b may have a partition portion 55b disposed between the first winding portion 20a and the second winding portion 20b. The partition portion 55b protrudes from the surface of the second spacer 5b that faces the second end portion 2b of the coil 2. The direction in which the partition portion 55b protrudes is opposite to the X direction. The partition portion 55b is sandwiched between the opposing side surfaces of the first winding portion 20a and the second winding portion 20b. The partition portion 55b is provided in a region close to the second end portion 2b of the coil 2. The dimension of the partition portion 55b in the X direction is less than half the dimension of the winding portions 20 in the X direction. The upper end portion of the partition portion 55b is lower than the upper surface of the coil 2 so that the connecting portion 22 of the coil 2 shown in FIG. 10 can pass through.

### Protrusion

Furthermore, the second spacer 5b may have protrusions 53 that protrude from the surface that faces the second end portion 2b of the coil 2. The direction in which the protrusions 53 protrude is opposite to the X direction. The protrusions 53 come into contact with the inner surfaces of the side surfaces of the winding portions 20. Two protrusions 53 are provided for each of the winding portions 20. The protrusions 53 are disposed between the inner peripheral surfaces of the winding portions 20 and the outer peripheral surfaces of the inner core portions 30. The portions of the outer peripheral surfaces of the inner core portions 30 where the protrusions 53 are arranged do not come into contact with the inner peripheral surfaces of the winding portions 20. The protrusions 53 have a function of positioning the winding portions 20 on the second spacer 5b. In this example, the cross sections of the protrusions 53 taken perpendicular to the X direction are C-shaped corresponding to the inner surfaces of the side surfaces of the winding portions 20. The dimension of the protrusions 53 in the X direction is shorter than the dimension of the support portions 54 in the X direction.

In this example, the protrusions 53 and the partition portion 55b are integrated with the second spacer 5b.

As an alternative to the present embodiment, the support portions 54 may be provided on the second spacer 5b. In this case, the first spacer 5a may have the protrusions 53 instead of the support portions 54.

The reactor 1 of this embodiment shown in FIG. 1 is a low-profile type of reactor. Here, “low-profile” means that the vertical dimension is smaller than the horizontal dimension. In this example, when the magnetic core 3 is viewed from the X direction, a vertical dimension H of the magnetic core 3 is ⅓ or less of a horizontal dimension W. Hereinafter, the ratio of the vertical dimension H to the horizontal dimension W will be referred to as the aspect ratio H/W. The vertical direction is the Z direction. The vertical dimension H is the length of the short side of the smallest rectangle that envelops the outline shape of the outer periphery of the magnetic core 3 when viewed from the X direction. The vertical dimension H corresponds to the thickness. The horizontal direction is the Y direction. The horizontal dimension W is the length of the long side of the smallest rectangle that envelops the outline shape of the outer periphery of the magnetic core 3 when viewed from the X direction. The horizontal dimension W corresponds to the width. The aspect ratio H/W may further be ¼ or less, ⅕ or less, or ⅙ or less.

The vertical dimension H of the magnetic core 3 is, for example, 20 mm or less. In this example, the vertical dimension of the coil 2 is substantially the same as the vertical dimension H of the magnetic core 3. The vertical dimension H of the magnetic core 3 may further be 10 mm or less.

### Reactor Manufacturing Method

The reactor 1 of this embodiment can be manufactured by a reactor manufacturing method described below. The reactor manufacturing method includes the following steps A and B.
A: step of attaching the spacers 5 to the coil 2
B: step of molding the inner core portions 30 and the outer core portion 35 from a composite material in the state where the spacers 5 are attached to the coil 2

### Step A

By attaching the spacers 5 to the coil 2, a coil assembly in which the spacers 5 are attached to the coil 2 is obtained. The spacers 5 are attached to the coil 2 as follows. The support portions 54 and the gap plates 4 of the first spacer 5a are inserted into the winding portions 20 at the first end portion 2a of the coil 2, and the first spacer 5a is attached to the first end portion 2a. Due to attaching the first spacer 5a to the first end portion 2a, the gap plates 4 are disposed inside the winding portions 20, and the gap plates 4 are positioned by the support portions 54. Furthermore, due to the support portions 54 coming into contact with the inner peripheral surfaces of the winding portions 20, the first spacer 5a is positioned relative to the first end portion 2a. The protrusions 53 of the second spacer 5b are inserted into the winding portions 20 at the second end portion 2b of the coil 2, and the second spacer 5b is attached to the second end portion 2b. Due to the protrusions 53 coming into contact with the inner peripheral surfaces of the winding portion 20, the second spacer 5b is positioned relative to the second end portion 2b.

### Step B

After the spacers 5 are attached to the coil 2, the inner core portions 30 and the outer core portions 35 are molded onto the coil assembly, thus forming the magnetic core 3. The inner core portions 30 and the outer core portions 35 are molded as follows. The coil assembly is placed in a mold and the composite material is injected into the mold. The mold has cavities for molding the outer core portions 35. The mold is provided with pins for positioning the coil assembly. The composite raw material is introduced into the coil 2 and into the cavities. The composite raw material may be introduced such that it flows from the first end portion 2a toward the second end portion 2b of the coil 2, or may be introduced such that it flows from the first end portion 2a toward the second end portion 2b. The cavities are in communication with the interior of the winding portions 20, and the raw material is introduced from the cavities into the winding portions 20. The raw material introduced into the winding portions 20 passes through the through-holes 43 of the gap plates 4 and fills the winding portions 20. If there are gaps between the outer peripheral surfaces of the gap plates 4 and the inner peripheral surfaces of the winding portions 20, the raw material passes through the gaps and fills the interior of the winding portions 20. After the composite raw material fills the winding portions 20 and the cavities, the resin that forms the composite material is allowed to solidify, thereby integrally molding the inner core portions 30 and the outer core portions 35.

### Converter and Power Conversion Device

The reactor 1 of this embodiment can be used for applications that satisfy the following power conditions. The power conditions are, for example, a maximum DC current of about 100 A or more and 1000 A or less, an average voltage of about 100 V or more and 1000 V or less, and an operating frequency of about 5 kHz or more and 100 kHz or less. The reactor 1 of this embodiment can be used as a component of a converter typically mounted in a vehicle such as an electric vehicle or a hybrid vehicle, and as a component of a power conversion device that includes such a converter.

As shown in FIG. 11, a vehicle 1200, which is a hybrid vehicle or an electric vehicle, includes a main battery 1210, a power conversion device 1100 connected to the main battery 1210, and a motor 1220 used for travel by being driven using power supplied from the main battery 1210. The motor 1220 is typically a three-phase AC motor. The motor 1220 is for driving wheels 1250 during travel, and also functions as a generator during regeneration. In the case of a hybrid vehicle, the vehicle 1200 includes an engine 1300 in addition to the motor 1220. In FIG. 11, an inlet is shown as a charging location for charging the vehicle 1200, but an aspect including a plug is also possible.

The power conversion device 1100 includes a converter 1110 connected to the main battery 1210, and an inverter 1120 that is connected to the converter 1110 and performs conversion between DC and AC. While the vehicle 1200 travels, the converter 1110 in this example steps up the input voltage of the main battery 1210, which is approximately 200 V or more and 300 V or less, to approximately 400 V or more and 700 V or less, and supplies the resulting power to the inverter 1120. During regeneration, the converter 1110 steps down the input voltage received from the motor 1220 via the inverter 1120 to a DC voltage suitable for the main battery 1210, and charges the main battery 1210 with the resulting power. The input voltage is a DC voltage. While the vehicle 1200 is traveling, the inverter 1120 converts the DC power stepped up by the converter 1110 into predetermined AC power and supplies the resulting power to the motor 1220, whereas during regeneration, the inverter 1120 converts the AC power output from the motor 1220 into DC power and outputs the resulting power to the converter 1110.

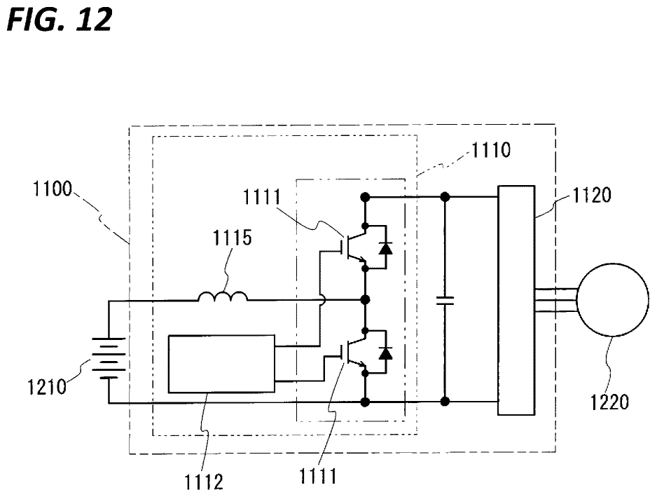

As shown in FIG. 12, the converter 1110 includes a plurality of switching elements 1111, a drive circuit 1112 that controls the operation of the switching elements 1111, and a reactor 1115, and performs input voltage conversion by repeatedly performing ON/OFF operations. Input voltage conversion here means stepping up or down. The switching elements 1111 can be a power device such as a field effect transistor or an insulated gate bipolar transistor. The reactor 1115 utilizes a coil property of suppressing change in the current flowing through the circuit, and has a function of smoothing such change when the current attempts to increase or decrease due to switching operations. The reactor 1 described in the embodiment is provided as the reactor 1115.

In addition to the converter 1110, the vehicle 1200 includes a power supply device converter 1150 connected to the main battery 1210, and an auxiliary power supply converter 1160 that is connected to the main battery 1210 and a sub-battery 1230 serving as a power source for an auxiliary device 1240, and converts a high voltage from the main battery 1210 into a low voltage. The converter 1110 typically performs DC-DC conversion, whereas the power supply device converter 1150 and the auxiliary power supply converter 1160 perform AC-DC conversion. Some power supply device converters 1150 perform DC-DC conversion. The reactor of the power supply device converter 1150 and the auxiliary power supply converter 1160 can be a reactor that has a configuration similar to that of the reactor 1 of the embodiment, with appropriate modifications in terms of size, shape, and the like. Furthermore, the reactor 1 of the embodiment can also be used in a converter that performs input power conversion, such as a converter that only performs stepping up or a converter that only performs stepping down.

The present invention is not limited to these examples, but rather is defined by the scope of the claims, and is intended to include all modifications within a meaning and scope equivalent to the claims.

A configuration is possible in which one winding portion 20 is provided. The magnetic core 3 may be θ-shaped instead of O-shaped. A θ-shaped magnetic core includes one middle core portion, two side core portions, and two end core portions. The middle core portion is disposed inside the coil. The side core portions are arranged parallel with the middle core portion on the outside of the coil. In other words, the middle core portion is disposed so as to be sandwiched between the two side core portions. One of the two end core portions connects the first end portions of the middle core portion and the side core portions that are arranged side by side. The remaining end core portion connects the second end portions of the middle core portion and the side core portions that are arranged side by side. In other words, the θ-shaped magnetic core is shaped like two E-shaped core pieces joined together. The middle core portion, the side core portions, and the end core portions are all integrally molded from a composite material. In the θ-shaped magnetic core, the middle core portion corresponds to the inner core portions, and the side core portions and the end core portions correspond to the outer core portions.

### List of Reference Numerals

1 reactor
2 coil, 2a first end portion, 2b second end portion
20 winding portion, 20a first winding portion, 20b second winding portion
21 terminal portion, 21a first terminal portion, 21b second terminal portion
22 connecting portion, 23 joint
3 magnetic core
30 inner core portion, 30a first inner core portion, 30b second inner core portion
31 first core portion, 32 second core portion
33 connecting core portion, 331 first connecting core portion, 332 second connecting core portion
35 outer core portion, 35a first end core portion, 35b second end core portion
37 recess
4 gap plate
41 first surface, 42 second surface, 43 through-hole
45 hook portion, 451 shaft portion, 452 head portion
5 spacer, 5a first spacer, 5b second spacer
52a, 52b opening portion
53 protrusion, 54 support portion
55a, 55b partition portion, 57 recess
H vertical dimension, W horizontal dimension
1100 power conversion device, 1110 converter
1111 switching element, 1112 drive circuit
1115 reactor, 1120 inverter
1150 power supply device converter, 1160 auxiliary power supply converter
1200 vehicle
1210 main battery, 1220 motor
1230 sub-battery, 1240 auxiliary device, 1250 wheel, 1300 engine

1. A reactor comprising:
a coil;
a magnetic core having an inner core portion disposed inside the coil and an outer core portion disposed outside the coil; and
a spacer disposed at at least one end portion of the coil,
wherein the inner core portion includes:
a first core portion and a second core portion arranged side by side in an X direction extending along an axis of the coil;
a gap plate disposed between the first core portion and the second core portion; and
a connecting core portion connecting the first core portion and the second core portion to each other,
the first core portion, the second core portion, and the connecting core portion are integrally molded from a composite material in which a soft magnetic powder is dispersed in a resin,
the spacer includes a first spacer having an opening portion in which an end portion of the first core portion is disposed,
the first spacer has a support portion supporting the gap plate,
the gap plate has:
a first surface in contact with the first core portion;
a second surface in contact with the second core portion; and
a hook portion provided on the second surface, the hook portion has:
a shaft portion protruding in the X direction from the second surface; and
a head portion protruding from a leading end of the shaft portion in a direction intersecting the X direction, and
the support portion is connected to the first surface of the gap plate.

2. The reactor according to claim 1,
wherein the gap plate has a through-hole extending from the first surface to the second surface, and
the connecting core portion includes a first connecting core portion provided in the through-hole.

3. The reactor according to claim 1,
wherein in a view of the inner core portion from the X direction, an area of an outline of the gap plate is smaller than an area of an outline of each of the first core portion and the second core portion, and
the connecting core portion includes a second connecting core portion provided outward of an outer peripheral surface of the gap plate.

4. The reactor according to claim 2,
wherein in a view of the gap plate from the X direction, the head portion is at a position overlapping the through-hole.

5. The reactor according to claim 1,
wherein the connecting core portion has a cross-sectional area of 1 mm² or more and 20 mm² or less.

6. The reactor according to claim 1,
wherein the gap plate has a thickness of 0.5 mm or more and 3 mm or less.

7. The reactor according to claim 1,
wherein the outer core portion is integrally molded with the first core portion, the second core portion, and the connecting core portion.

8. The reactor according to claim 1,
wherein in a view of the magnetic core from the X direction, a vertical dimension of the magnetic core is ⅓ or less of a horizontal dimension of the magnetic core.

9. The reactor according to claim 1,
wherein the magnetic core has a vertical dimension of 20 mm or less.

10. A converter comprising:
the reactor according to claim 1.

11. A power conversion device comprising:
the converter according to claim 10.

12. (canceled)

13. (canceled)
